(19) United States
(12) Patent Application Publication
(10) Pub. No.: US 2024/0188002 A1
(43) Pub. Date: Jun. 6, 2024

(54) METHODS FOR CHANGING OPERATING MODE OF A WIRELESS COMMUNICATION DEVICE AND ASSOCIATED DEVICES

(71) Applicant: SAGEMCOM BROADBAND SAS, Bois-Colombes (FR)

(72) Inventors: Clément PARISOT, Bois-Colombes (FR); Arthur JARDIN, Bois-Colombes (FR)

(21) Appl. No.: 18/527,185

(22) Filed: Dec. 1, 2023

(30) Foreign Application Priority Data
Dec. 2, 2022 (FR) 2212671

(51) Int. Cl. H04W 52/36; H04W 52/40

(52) U.S. Cl. CPC H04W 52/36; H04W 52/40

(57) ABSTRACT

A method is described, carried out by a wireless communication device comprising a wireless communication interface, said interface being configured to operate selectively according to several operating modes comprising a first active operating mode and a second operating mode with reduced consumption relative to the first mode and enabling the reception of at least one type of transmission packet;

the device being subjected to a constraint of implementing an action that must be carried out continuously when the interface operates at an emission power greater than a threshold over a communication channel of a given type, the action being incompatible with the second mode;

the method comprising, to change from the first mode to the second mode,

a) in a first step, lowering the transmission power below the threshold;

b) in a second step, deactivating the action;

c) in a third step, activating the second mode.

The invention also relates to a method for changing from the second mode to the first mode and devices implementing the methods.

### CROSS-REFERENCE TO RELATED APPLICATIONS

The present application claims priority to French Application No. 2212671 filed with the Intellectual Property Office of France on Dec. 2, 2022, which is incorporated herein by reference in their entirety for all purposes.

### TECHNICAL FIELD

Methods are described for changing the operating mode of a wireless communication device and associated devices. The methods and devices can advantageously be used in the context of a constraint related to detecting the presence of radars on a channel.

### TECHNICAL BACKGROUND

In a wireless communication network, the use of certain channels or frequency bands may require compliance with technical and regulatory constraints, in particular relative to possible interference with other devices on the same channels. For example, it may be required for a wireless communication network device to monitor the presence of radar signals on at least part of the channels on which the device may need to operate. This monitoring in turn imposes requirements on the operation of the device, in particular concerning the possibilities of placing certain modules or functions on standby, and can be difficult to reconcile with the specifications of the device or even with other regulations regarding energy saving.

### SUMMARY

One or more embodiments relate to a method carried out by a wireless

communication device comprising a wireless communication interface, said interface being configured to selectively operate according to several operating modes comprising
a first active operating mode; and
a second operating mode with reduced consumption relative to the first mode and enabling the reception of at least one type of transmission packet;
the device being subjected to a constraint of implementing an action that must be carried out continuously when the interface operates at a transmission power greater than a threshold over a communication channel of a given type, the action being incompatible with the second mode;
the method comprising, to change from the first mode to the second mode,
a) in a first step, lowering the transmission power below the threshold;
b) in a second step, deactivating the action;
c) in a third step, activating the second mode.

According to one or more embodiments, the second mode alternately comprises standby phases and active phases, the interface being adapted to be able to receive at least one wake-up packet during the active standby phases of the second operating mode.

According to one or more embodiments, the method comprises storing the power level before it is lowered.

According to one or more embodiments, the action is a detection of the presence of radars on the channel of given type.

According to one or more embodiments, the method comprises, before steps (a) to (c), a verification that the action is indeed carried out, steps (a) and (b) being carried out only if this verification is positive.

According to one or more embodiments, the method comprises, in the event of positive verification, storing information indicative of the fact that the action was indeed performed.

According to one or more embodiments, the channel of the given type is a channel with dynamic frequency selection.

According to one or more embodiments, the method comprises, before lowering the power, transmitting a message to an access point with which the wireless communication device is associated, said message indicating the targeted power level after lowering.

According to one or more embodiments, the message further comprises a datum indicative of the reason for lowering the power.

One or more embodiments relate to a wireless communication device comprising

a wireless communication interface, said interface being configured to selectively operate according to several operating modes comprising
a first active operating mode; and
a second operating mode with reduced consumption relative to the first mode and enabling the reception of at least one type of transmission packet;
the device being subjected to a constraint of implementing an action that must be carried out continuously when the interface operates at a transmission power greater than a threshold over a communication channel of a given type, the action being incompatible with the second mode;
the device being configured to:
   a) in a first step, lower the transmission power below the threshold;
   b) in a second step, deactivate the action;
   c) in a third step, activate the second mode.

According to one or more embodiments, the above device being further configured to implement one of the methods described.

One or more embodiments relate to a method implemented by a wireless communication device comprising a wireless communication interface, said interface being configured to selectively operate according to several operating modes comprising
a first active operating mode; and
a second operating mode with reduced consumption relative to the first mode and enabling the reception of at least one type of transmission packet;
the device being subjected to a constraint of implementing an action that must be carried out continuously when the interface operates at a transmission power greater than a threshold over a communication channel of a given type, the action being incompatible with the second mode;
the method comprising, to change from the second mode to the first mode,
(a) in a first step, activating the first mode;
(b) in a second step, activating the action;
(c) in a third step, increasing the transmission power above the threshold.

According to one or more embodiments, the method comprises, before increasing the power, transmitting a message to an access point with which the wireless communication device is associated, said message indicating the targeted power level after increasing.

According to one or more embodiments, the message further comprises a datum indicative of the reason for increasing the power.

One or more embodiments relate to a wireless communication device comprising a wireless communication interface, said interface being configured to selectively operate according to several operating modes comprising
a first active operating mode; and
a second operating mode with reduced consumption relative to the first mode and enabling the reception of at least one type of transmission packet;
the device being subjected to a constraint of implementing an action that must be carried out continuously when the interface operates at a transmission power greater than a threshold over a communication channel of a given type, the action being incompatible with the second mode;
the device comprising
   the device being configured to
   (a) in a first step, activate first mode;
   (b) in a second step, activate the action;
   (c) in a third step, increase the transmission power above the threshold.

According to one or more embodiments, the above device is further configured to implement one of the methods described.

One or more embodiments relate to a non-volatile storage medium readable by a device provided with a processor, said medium comprising instructions which, when the program is executed by a processor of a device, cause the device to implement at least one of the described methods.

One or more embodiments relate to a wireless communication device comprising a processor, a memory and software code, the processor being configured, when executing the software code, to cause the device to implement at least one of the methods described.

### BRIEF DESCRIPTION OF THE FIGURES

Further features and advantages will become apparent from the following detailed description, which may be understood with reference to the attached drawings in which:

FIG. 1 is a block diagram of a system comprising an access point of a wireless network and a wireless station according to a non-limiting embodiment;

FIG. 2 is a schematic flowchart showing several constraints to be respected according to one or more exemplary embodiments;

FIG. 3 is a schematic diagram showing states of a wireless device according to one or more embodiments;

FIG. 4 is a flowchart of a method for entering low-consumption mode according to a non-limiting exemplary embodiment;

FIG. 5 is a flowchart of a method for exiting low-consumption mode according to a non-limiting exemplary embodiment.

### DETAILED DESCRIPTION

In the following description, identical, similar or analogous elements will be referred to by the same reference numbers.

The block diagrams, flowcharts and message sequence diagrams in the figures illustrate the architecture, functionalities and operation of systems, devices, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or device to implement all or part of the functionalities of the blocks and/or steps of the processes or methods according to the exemplary embodiments. For example, the processor or controller may implement all or part of a method, and in this context may also communicate with other components to control them and/or to transmit data and/or to receive data, for implementing the method. The processor or controller therefore leads, alone or in conjunction with other components of a device with which it is integrated, to implementing the steps of a method. The software code can be stored in a memory or a readable medium accessible directly or via another module by the processor or controller.

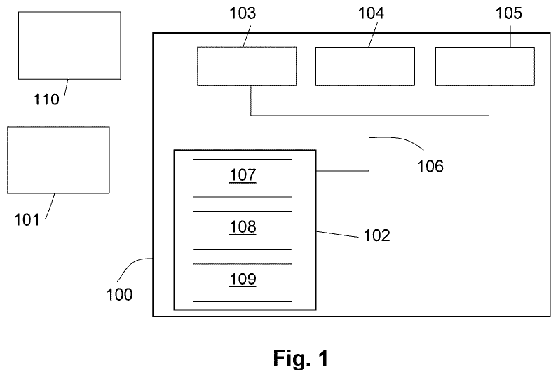

FIG. 1 is a block diagram of a communication network comprising a client device 100 of a wireless network and a point-of-access device 101 to this network, according to one or more embodiments. The devices 100 and 101 are able to communicate through the network bidirectionally. The client device 100 comprises a wireless communication interface 102, a processor 103, a random access memory 104 and a non-volatile memory 105. The various components of the device 100 are connected by a communication bus 106. The non-volatile memory comprises code executable by the processor 103, and in particular a driver software of the wireless interface. The processor 103 controls the operating modes of the wireless communication interface from among the various available modes detailed below, and activates or deactivates certain functionalities. The wireless communication interface 102 comprises a controller and a set of components ensuring the wireless communication functionality. The wireless communication interface meets, for example, standard IEEE 802.11.

The interface 102 is shown as having three functionalities. A first functionality is radar detection 107. This functionality can be activated or deactivated. A second functionality is the control 108 of the transmission power. This functionality allows the power to be adjusted to a desired level. A third functionality is the adjustment of the operating mode 109 of the interface 102. These modes may comprise an active mode wherein the interface operates in a nominal manner, an off mode wherein the interface is not powered, and a reduced or “low-consumption” mode, with “intermittent standby,” alternating active phases and standby phases. The various features are implemented through firmware executed by the wireless interface controller and, generally, controlled by the processor 103 via the driver software.

In the following, it will be assumed that the client device 100 is associated with the access point 101.

FIG. 1 also shows a radar source 110.

According to one embodiment, during a standby mode of the client device:
the processor 103 is turned off;
the random access memory stores certain operating data of the device 100 and keeps them while the device 100 is in standby mode;
the wireless communication interface 102 is in the low-consumption mode.

The interface 102 and/or the device 100 are subjected to several operating constraints. These constraints may come from various sources. Some of these constraints can be defined by one or more specifications or standards with which the device must conform. Other constraints can be related to certification criteria with which the device seeks to comply. Still other constraints may be derived from specific technical or commercial choices, be imposed by clients or partners, or else be due to a regulatory requirement. Other sources of constraints may exist.

According to one embodiment, the constraints are as follows:
C1—beyond a wireless transmission power threshold S1, the device 100 must implement at least one action requiring the wireless communication interface to be continuously active;
C2—a “low consumption” mode is necessary, this mode comprising placing the wireless communication interface intermittently on standby;
C3—in the standby mode of the client device 100, the ability to receive at least some types of data packets must be maintained (called “connected standby mode” of the client device 100, wherein the wireless communication interface operates, when the latter is outside standby mode, at least with degraded performance with respect to the normal operating mode, but allows these types of packets to be received;
C4—when the device 100 is in standby mode, a maximum energy consumption threshold S2 by the device 100 must be respected.

An example of constraint C1 is the requirement to perform radar detection beyond the power threshold S1. This requirement may or may not be limited to one or more channels. European standard ETSI EN 301 893 V2.1.1 for example requires, for client devices of wireless local area networks operating on 5 GHz frequency bands and for a power threshold greater than or equal to 23 dBm for the effective radiated power, that the client device be capable of detecting the radars present in the environment. This requirement relates to so-called DFS (Dynamic Frequency Selection) channels, described for example in standard IEEE 802.11h. This detection capacity is measured in certification and must reach a high success rate. To obtain it, the wireless communication interface 102 must remain listening on the radio channel continuously. An example of the action to be implemented mentioned above is therefore the implementation of radar detection.

An example of constraint C2 is the low consumption mode (designated by the acronym “WMM-PS” of the “Wi-Fi Alliance” certification) comprising periodic placement of the wireless interface in standby mode. During these periodic standby phases, the wireless interface 102 is, however, no longer in permanent listening mode for radar detection. The “low consumption” mode is therefore incompatible with constraint C1, but may be necessary to comply with a maximum power threshold in standby mode of the client device 100 (constraint C4) when operation, even partial, of the wireless interface is required during the standby of the client device 100 (constraint C3).

An example of constraint C3 is the option of being able to receive and/or transmit, even in standby mode of the client device, packets with low modulation (low bit rate and long range) using the wireless interface. An example type of packet that the wireless interface can be intended to receive, when the client device 100 is in connected standby mode, is a so-called “wake-up” packet. This type of packet forces a client device to leave standby mode and operate in normal mode.

An example of constraint C4 is the imposition by the European ErP (Energy-related Product) Regulation, of a maximum average consumption limit when the client device is in standby mode. For a client device of a wireless network, the maximum threshold S2 is for example 2 W in connected standby mode. The client device can operate with a power below the threshold S2 by keeping the wireless interface in operation, but only if the wireless interface is in “low consumption” mode (therefore including intermittent standby periods of the wireless interface); otherwise, the threshold of 2 W is exceeded.

An additional constraint comes from a desire to ensure quality and range of the wireless communication when the wireless communication interface is in the active state, which requires a high transmission power.

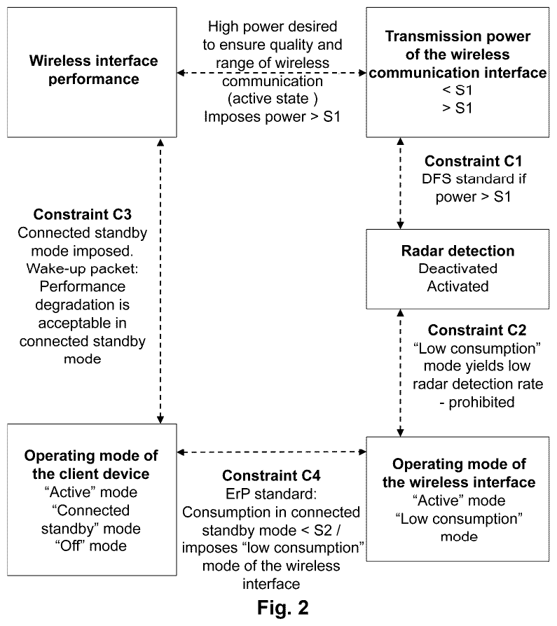

FIG. 2 is a schematic diagram illustrating these various constraints as well as the links between constraints.

According to one or more embodiments, the passage of the client device from an active operating mode outside standby to standby mode is performed as follows:
Optionally, before the switching from the active mode to the standby mode, the client device records the current state in the form of one or more operating parameters—indeed, it will then not be necessary to determine this or these parameter(s), which can be taken up directly. This facilitates and/or accelerates a passage from the standby mode to the active mode. The transmission power at which the wireless interface works is thus stored.
The client device checks whether it is transmitting over a channel for which the detection of radars is mandatory, for example a DFS channel. If this is not the case, the next two steps are not implemented.
In a first step, the transmission power of the wireless communication interface is reduced below the threshold S1 requiring the detection of radars.

This detection is then no longer mandatory.
In a second step, radar detection is deactivated.
In a third step, the wireless communication interface is placed in the reduced consumption operating mode.

According to one embodiment, this reduced consumption operating mode is the “low consumption” mode with intermittent standby to contribute to respecting the threshold S2, which is the overall threshold for the entire client device when the latter is in standby mode.

Thus, the consumption of the wireless communication interface is reduced in two steps, in a first step by placing itself at a power level S3 below the threshold S1 and making it possible to eliminate the obligation for radar detection, and in a second step by implementing the low-consumption mode of the interface. In the low-consumption mode, the power remains at the level S3 and a supplementary consumption reduction is obtained by the intermittent placement in standby mode.

No dead time is thus present in the action of detecting radars as long as this detection is required, and the related constraint C1 is entirely respected during the transition to standby mode.

Thus, the client device may have a significant transmission power in the nominal operating mode, even if this requires implementing radar detection, while being able to switch unhindered to a low-consumption mode.

The client device can identify the “DFS” nature of a channel for example in a lookup table based on the number of the channel. Indeed, the numbers of the DFS channels are predetermined.

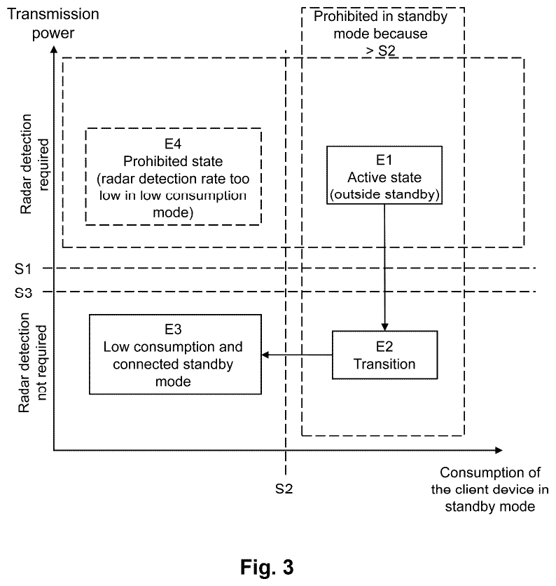

FIG. 3 is a diagram of the states of the wireless communication interface according to a non-limiting embodiment. This diagram presents these states relative to the transmission power of the wireless interface and the consumption of the client device in standby mode.

A first state E1 is the active state; the transmission power is situated above the power threshold S1, requiring radar detection. The consumption of the client device including the wireless communication interface is above the consumption threshold S2.

A second state E2 is a transient state between state E1 and state E3, where the wireless communication interface is controlled to operate at the transmission power S3 below the power threshold S1, but without being in low-consumption and connected standby mode and not allowing the client device to comply with the standby consumption threshold S2.

A third state E3 is a state corresponding to the low-consumption operating mode; when the wireless communication interface is in this state, the client device can, once the components of the device other than the wireless communication interface have been placed in standby mode, comply with the consumption threshold S2 in standby mode.

A fourth state E4 corresponds to an operation of the wireless communication interface with a transmission power greater than the threshold S1 (and consequently with the obligation to implement radar detection) and in low-consumption mode with intermittent standby. Since these two aspects are incompatible, this is a prohibited state.

In state E3, the wireless communication interface is in low consumption mode. The transmission power, remaining at the threshold S3 in this mode, is lower and the range of radio communications decreases accordingly relative to operation at nominal power. However, during periods outside the low consumption mode, certain types of packets can always be received and/or sent despite the drop in power. These are in particular packets with low modulation (low bit rate and long range). A wake-up packet can then trigger a passage of the client device to the active.

Outside the wake-up packets, other types of packets received or sent at the reduced transmission power S3 can, depending on the implementation or the standardized constraints, comprise “null” packets received from the access point to verify that the client device is still present, acknowledgment packets (in particular the aforementioned “null” packets) transmitted by the client device, or packets received from the access point regarding a key update, such as the group key called “GTK”.

According to an optional variant, the client device is configured to send the access point a message indicating to the access point with which it is associated that it is lowering its transmission power, before this lowering becomes effective.

Indeed, if the access point itself observes a drop in the transmission power of the client device, the access point can be made to believe that the client device has moved away from it and initiate a steering procedure to attempt to bring the client device toward an access point offering a more efficient connection. By receiving the message from the client device that the lowering of the transmission power is voluntary, the access point with which the device is associated will know that the switching procedure is unnecessary. In addition, the switching procedure would want the client device to leave its standby mode to manage the change of access point, which is not optimal in terms of energy savings.

According to one embodiment, when exiting the standby mode to enter the active mode, the client device sends a message indicating that it is returning to its original power.

According to a non-limiting embodiment, the message is included in a packet of the “action frame” type whose content is specific to the provider of the client device, as described by standard IEEE 802.11. A non-limiting example of the content of a packet carrying either of the two messages mentioned in the preceding paragraphs can be defined as follows:
A datum indicating the new transmission power (in dBm).

This transmission power is for example encoded as a signed integer, on two bytes.
A datum indicating the reason for the change in power.

This datum is, for example, made up of information that can have a value “entering standby mode” and a value “entering active mode.”

An example of this datum is a byte for which:
Bit 7 (‘is_modified’) indicates whether the new power is the power in operation in active mode (bit at zero) or a modified power (bit at 1).
   Bits 6 to 0 contain a 7-bit code indicating the reason for the change:
   0x00=“entering active mode”;

[symbol] 01=“entering standby mode”;

The other values are reserved for future use.

According to the present embodiment, the message contains at least the information indicating the new transmission power. The other data are optional.

A person skilled in the art will easily be able to determine other formats for one or more of these data.

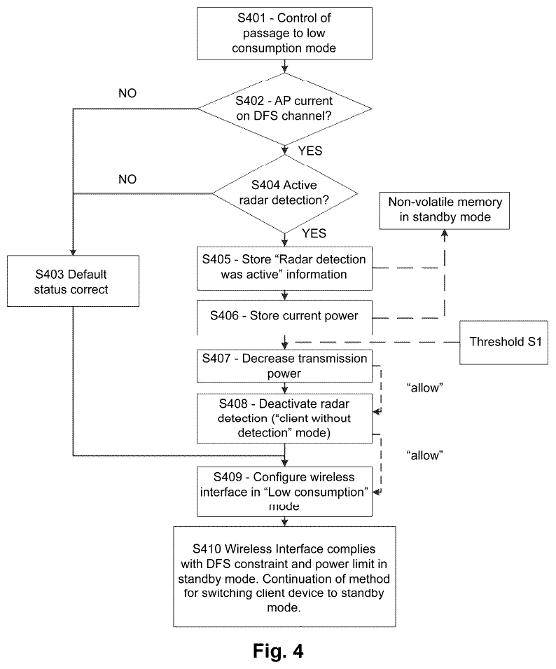

FIG. 4 is an algorithm flowchart of a method for placing the wireless interface in low consumption mode according to one or more non-limiting exemplary embodiments.

A passage to low consumption mode of the wireless communication interface is initiated (S401). This initiation occurs for example when the client device decides to place itself on standby.

Verification is then performed to determine whether the current transmission channel used by the access point is a channel requiring radar detection (S402).

If the verification in S402 is negative, the client device estimates (S403) that the state of the wireless communication interface is correct to allow the placement in low consumption mode (S409). This placement in low consumption mode is followed, if necessary, by the continued placement on standby of the client device (S410).

According to an alternative embodiment, the wireless interface is in low consumption mode (with intermittent standby) by default as soon as the channel on which it operates with the access point does not require radar detection. According to this alternative, it is therefore not necessary, if the test in S402 is negative, to configure the wireless interface in low consumption mode, since this interface is already in this mode. It is possible, according to this variant, to pass directly from S403 to S410 without passing through S409.

Returning to the main embodiment, if one is indeed on a DFS channel, the client device determines (S404) whether the radar detection is active or not. Indeed, in some circumstances, it is possible to be on a DFS channel, but radar detection can be inactive due for example to specific features of the local regulation not necessarily requiring this detection. If radar detection is inactive, the client device will estimate (S403) that the state of the wireless communication interface is correct to allow the placement in low consumption mode (S409). The test in S404 for example allows the client device to operate both in countries imposing constraint C1 and in others where this is not the case.

If radar detection is active, the client device stores (S405) this information in memory, then stores (S406) the current transmission power. The transmission power is then lowered to a value below the threshold requiring radar detection (S407). The deactivation of radar detection then becomes possible; this is done in S408. It is then possible to switch to the low consumption mode (S409), then to continue, if necessary, the placement on standby of the client device (S410).

According to the present embodiment, if radar detection is not active, no information on the state of the radar detection is stored; when entering the active mode, the client device will implicitly consider that the detection was deactivated. According to one alternative embodiment, explicit information on the state of the radar detection is also stored if radar detection is not active.

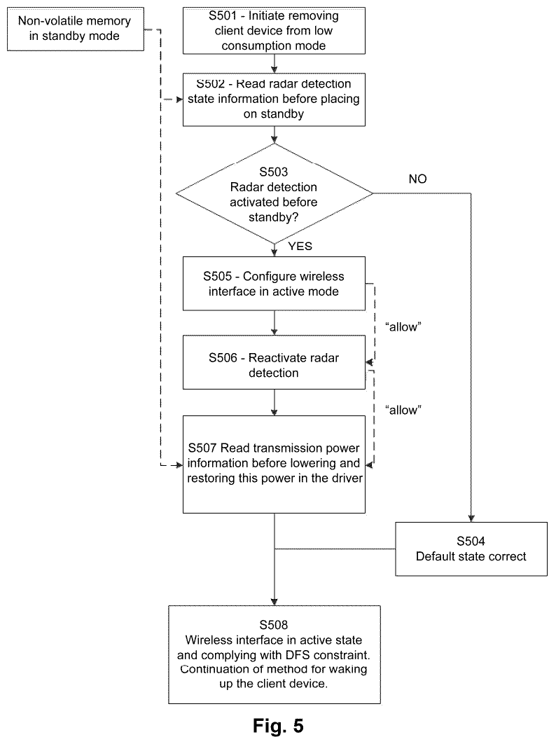

FIG. 5 is an algorithm flowchart of a method for placing the wireless interface in the active mode (removed from low consumption mode) according to one or more non-limiting exemplary embodiments. According to the embodiment presented here, the method of FIG. 5 uses information previously stored during the placement in low consumption mode.

In S501, an exit from the low consumption mode of the wireless communication interface is initiated. This initiation occurs for example when the client device is requested to leave the standby mode.

The state of the radar detection before the placement in low consumption mode is then obtained (S502). It is verified whether radar detection was active before the placement in low consumption mode (S503). If this is not the case, the device considers that this detection does not need to be activated and that the state of the wireless communication interface is correct in this respect (S504), before, if applicable, the other components of the client device are woken up (S508), if this is not already the case.

If the verification of the state of the radar detection in S503 shows that this detection was active, then the operating mode of the wireless communication interface is changed from the low consumption mode to the active mode (S505). Radar detection is then reactivated (S506). The transmission power value of the wireless communication interface is obtained and this power is restored (S507) before, if applicable, continuing to switch other components of the client device to the active state (S508).

### REFERENCE SIGNS

100—Client device
101—Access point device
102—Wireless network interface
103—Processor
104—Random access memory
105—Read-only memory
106—Communication bus
107—Transmission power control
108—Radar detection
109—Operating mode
110—Radar wave transmitter

1. A method carried out by a wireless communication device comprising a wireless communication interface,
said interface being configured to selectively operate according to several operating modes comprising
a first active operating mode; and
a second operating mode with reduced consumption relative to the first mode and enabling the reception of at least one type of transmission packet;
the device being subjected to a constraint of implementing an action that must be carried out continuously when the interface operates at an emission power greater than a threshold over a communication channel of a given type, the action being incompatible with the second mode;
the method comprising, to change from the first mode to the second mode,
a) in a first step, lowering the transmission power below the threshold;
b) in a second step, deactivating the action;
c) in a third step, activating the second mode.

2. The method according to claim 1, wherein the second mode alternately comprises standby phases and active phases, the interface being adapted to be able to receive at least one wake-up packet during the active phases of the second operating mode.

3. The method according to claim 1, comprising storing the power level before it is lowered.

4. The method according to claim 1, wherein the action is a detection of the presence of radars on the channel of given type.

5. The method according to claim 1, comprising, before steps (a) to (c), a verification that the action is indeed carried out, steps (a) and (b) being carried out only if this verification is positive.

6. The method according to claim 5, comprising, in the event of positive verification, storing information indicative of the fact that the action was indeed performed.

7. The method according to claim 1, wherein the channel of the given type is a channel with dynamic frequency selection.

8. The method according to claim 1, comprising, before lowering the power, transmitting a message to an access point with which the wireless communication device is associated, said message indicating the targeted power level after lowering.

9. The method according to claim 8, the message further comprising a datum indicative of the reason for lowering the power.

10. A method carried out by a wireless communication device comprising a wireless communication interface,
said interface being configured to selectively operate according to several operating modes comprising
a first active operating mode; and
a second operating mode with reduced consumption relative to the first mode and enabling the reception of at least one type of transmission packet;
the device being subjected to a constraint of implementing an action that must be carried out continuously when the interface operates at an emission power greater than a threshold over a communication channel of a given type, the action being incompatible with the second mode;
the method comprising, to change from the second mode to the first mode,
(a) in a first step, activating the first mode;
(b) in a second step, activating the action;
(c) in a third step, increasing the transmission power above the threshold.

11. The method according to claim 10, comprising, before increasing the power, transmitting a message to an access point with which the wireless communication device is associated, said message indicating the targeted power level after increasing.

12. The method according to claim 11, the message further comprising a datum indicative of the reason for increasing the power.

13. A wireless communication device comprising a wireless communication interface, said interface being configured to selectively operate according to several operating modes comprising
a first active operating mode; and
a second operating mode with reduced consumption relative to the first mode and enabling the reception of at least one type of transmission packet;
the device being subjected to a constraint of implementing an action that must be carried out continuously when the interface operates at an emission power greater than a threshold over a communication channel of a given type, the action being incompatible with the second mode;
the device being configured to:
a) in a first step, lower the transmission power below the threshold;
b) in a second step, deactivate the action;
c) in a third step, activate the second mode.

14. The device according to claim 13, configured to carry out a method according to claim 2.

15. A wireless communication device comprising a wireless communication interface, said interface being configured to selectively operate according to several operating modes comprising
a first active operating mode; and
a second operating mode with reduced consumption relative to the first mode and enabling the reception of at least one type of transmission packet;
the device being subjected to a constraint of implementing an action that must be carried out continuously when the interface operates at an emission power greater than a threshold over a communication channel of a given type, the action being incompatible with the second mode;
the device being configured to
(a) in a first step, activate first mode;
(b) in a second step, activate the action;
(c) in a third step, increase the transmission power above the threshold.

16. The device according to claim 15, said device being configured to, before increasing the power, transmit a message to an access point with which the wireless communication device is associated, said message indicating the targeted power level after increasing.

17. The device according to claim 15, wherein the message further comprises a datum indicative of the reason for increasing the power.
